(19) United States
(12) Patent Application Publication
(10) Pub. No.: US 2011/0264532 A1
(43) Pub. Date: Oct. 27, 2011

(54) SOCIAL ADVERTISING PLATFORM

(75) Inventors: Alan C. Chan, Toronto (CA); Derrick W. Or, San Mateo, CA (US)

(73) Assignee: BREAD LABS INC., San Mateo, CA (US)

(21) Appl. No.: 13/182,604

(22) Filed: Jul. 14, 2011

Related U.S. Application Data
(63) Continuation of application No. 13/088,287, filed on Apr. 15, 2011.
(60) Provisional application No. 61/325,264, filed on Apr. 16, 2010.
(60) Provisional application No. 61/330,317, filed on May 1, 2010.

(51) Int. Cl. G06Q 30/00

(52) U.S. Cl. 705/14.66

(57) ABSTRACT

Methods and systems for facilitating a social advertising platform are provided. According to one embodiment, a method is provided for enabling sharing of content by members of a peer-to-peer social advertising service that also promotes companies, products, services, organizations, charities and/or causes which they endorse. Profile information is maintained for each member and includes a list of brands, products, services, companies, organizations, charities or causes recommended or endorsed by the member. A shared link is generated corresponding to a destination link through which a member can share content associated with the destination link with third parties via social media. Responsive to receiving a click-through event for the shared link, the requestor is redirected to a social advertisement containing advertising content selected based upon the list of things endorsed by the member. After temporarily displaying the advertising content, the requestor is then redirected to the destination link.

### CROSS-REFERENCE TO RELATED APPLICATIONS

This application is a continuation of U.S. patent application Ser. No. 13/088,287, filed Apr. 15, 2011, which claims the benefit of U.S. Provisional Application No. 61/325,264, filed on Apr. 16, 2010 and U.S. Provisional Application No. 61/330,317, filed on May 1, 2010, each of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2010-2011, Bread Labs, Inc.

### BACKGROUND

1. Field

Embodiments of the present invention generally relate to the field of electronic and online advertising and monetization of content. In particular, embodiments of the present invention relate to a social and user-generated ad platform and methods, tools and systems relating thereto that enable content creators to share interesting links while concurrently being rewarded for endorsing their favorite brands, companies, organizations, charities, causes, products and/or services.

2. Description of the Related Art

The number of Internet users sharing links on social media networks has increased dramatically over the past few years. With the proliferation of social media and blogging websites, more people are viewing online content that is created by their peers, friends or key influencers. In 2009, the number of users on Facebook increased to 350 million from 100 million in 2008. In 2009, the number of users on Twitter increased to 18 million. Also, there are currently 500,000 bloggers that earn advertising revenues. Existing online communities where users create content and share links include, but are not limited to, Facebook.com, MySpace.com, Blogger.com, WordPress.com and Twitter.com.

Internet websites typically include advertisements along with content. In the past, advertisements were shown to users based on the content on the website. Currently, advertisers focus their spending on advertisements that target the interests and needs of Internet users. One way to increase the relevancy of online advertisements is social media advertising, which makes use of various behavioral and demographic targeting methods. Spending on social media marketing is expected to be $716 million in 2010 and researchers predict 34% annual growth moving forward.

Another interesting trend is the number of Internet users sharing links targeting existing online content. For example, Internet users may include links to traditional newspaper websites, such as the New York Times online, in email messages, Facebook posts, blogs, Twitter streams (tweets), text messages, IM and the like. Social media has become an increasing source of online traffic for newspaper websites. The total share of upstream traffic from Twitter, Facebook and blogs for NYTimes.com was 6.46% of readers in December 2009, which is the equivalent of nearly one million readers. This constitutes a lot of advertising revenue.

Sharing links and information on the Internet is an increasing trend. On Facebook, 3.5 billion pieces of content such as web links, news stories, blog posts and notes are shared each week. A link is a selectable connection from one word, picture, or information object to another. In a multimedia environment, such as the World Wide Web, such objects can include sound and motion video sequences. The most common form of link is the highlighted word or picture that can be selected by the user (with a mouse or in some other fashion), resulting in the immediate delivery and view of another file. The highlighted object is referred to as an anchor. The anchor reference and the object referred to constitute a hypertext link.

In the past, publishers were traditionally newspapers, magazines and television; however, there is a huge shift and trend towards user generated content and empowerment of users on the Internet. A new type of publisher is emerging in the form of the everyday Internet user, or a social publisher.

A social publisher may be any person, group or organization that creates social content. Examples of social publishers include, but are not limited to, a user on a social network and a proprietor of a website or a web log (blog). Social networks may comprise of one or more social networking websites which offer an interactive network that combines blogs, groups, photos, e-mail, music, video, art, or some other content. Users typically sign up to use the social network and maintain personal websites that are customized according to the social publisher's personality, tastes and interests.

### SUMMARY

Methods and systems are described for facilitating a social advertising platform. According to one embodiment, a method is provided for enabling sharing of content by members of a peer-to-peer social advertising service that also promotes companies, products, services, organizations, charities and/or causes which they endorse. Profile information is maintained for each member and includes a list of brands, products, services, companies, organizations, charities or causes recommended or endorsed by the member. A shared link is generated corresponding to a destination link through which a member can share content associated with the destination link with third parties via social media. Responsive to receiving a click-through event for the shared link, the requestor is redirected to a social advertisement containing advertising content selected based upon the list of things endorsed by the member. After temporarily displaying the advertising content, the requestor is then redirected to the destination link.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating an exemplary network environment in which embodiments of the present invention may be implemented.

FIG. 2 is a software architecture block diagram conceptually illustrating exemplary functional units of a social advertising platform in accordance with one embodiment of the present invention.

FIG. 3 is a high-level flow diagram illustrating a content sharing process in accordance with an embodiment of the present invention from the sharer/fan perspective.

FIG. 4A is a high-level conceptual illustration showing the relationship among websites where shared links might be published, interstitial social advertisement pages and shared content in accordance with an embodiment of the present invention.

FIG. 4B conceptually illustrates an example of a redirect database in accordance with an embodiment of the present invention.

FIG. 5 illustrates an example of a share widget that may be used to generate indirect links to content via a social advertising platform in accordance with an embodiment of the present invention.

FIG. 6 illustrates another type of share widget that may be used to generate indirect links to content via a social advertising platform in accordance with an embodiment of the present invention.

FIG. 7 is a flow diagram illustrating a process of sharing content in accordance with an embodiment of the present invention from the perspective of the social advertising platform.

FIG. 8A is an example of an interstitial social advertisement page in accordance with an embodiment of the present invention.

FIG. 8B is another example of an interstitial social advertisement page in accordance with an embodiment of the present invention.

FIG. 9 is an example of a member page within the social advertising platform in accordance with an embodiment of the present invention.

FIG. 10A is an example of a brand page that may be hosted by the social advertising platform in accordance with an embodiment of the present invention.

FIG. 10B is an example of a cause page that may be hosted by the social advertising platform in accordance with an embodiment of the present invention.

FIG. 11 is an example of a computer system with which embodiments of the present invention may be utilized.

FIG. 12 is an example of a link conversion script in accordance with an embodiment of the present invention.

### DETAILED DESCRIPTION

Methods and systems are described for facilitating a social advertising platform. According to one embodiment, a free service is provided to address the problem of monetizing content on the web. A peer-to-peer advertising platform may pay content creators, like bloggers, reporters, and musicians for sharing interesting links and endorsing their favorite brands, products, services, companies, causes, charities and the like. When members of the social advertising service discover or publish interesting content, they can use a share bar to quickly create a shortened URL indirectly linking to the shared content. The shortened URL facilitates sharing via popular social networks, like Facebook, Twitter and blogs. Advertising revenue may be earned each time someone clicks on the shared link and views a brief LINKMERCIAL interstitial social advertisement page or SLICE interstitial social advertisement page (LINKMERCIAL and SLICE are trademarks of Bread Labs, Inc.). Depending upon the implementation, earnings may increase with the size of the sharer's audience and fan base.

In other embodiments, the member may automatically convert all outbound HTML links on their content providing websites to indirect links that first display an intermediate ad page before automatically linking to the originally targeted content.

According to one embodiment, the shared link, when clicked, leads to an advertisement on one website (e.g., one associated with a social advertising platform or the advertiser) and, subsequently, automatically reroutes to the target website. In this manner, any person or entity may become a publisher of content that includes links. The publisher may then be paid by the advertiser for the advertisement according to, but not limited to, the pay-per-impression or the pay-per-click revenue model. The shared links can occur on a network of computers (such as the Internet and websites), mobile devices or by any other electronic means. Common electronic means and websites include, but are not limited to, social media networks, blogs, emails and instant messenger services. The advertisement can comprise a LINKMERCIAL or SLICE social advertisement or other graphical, audio, multimedia, video, textual, visual and/or other information.

In one embodiment, a LINKMERCIAL or SLICE social advertisement is part of or itself represents a full-page, interactive, interstitial advertisement that is viewed before the target webpage loads. Members of the social advertising platform may control/limit advertising that is ultimately associated with their shared links by endorsing/recommending only their favorite companies, products, services, brands and/or causes. In one embodiment, selection of advertising content to be associated with a shared link is strictly limited to those corresponding with the companies, products, services, brands and/or causes expressly endorsed/recommended by the sharer.

LINKMERCIAL or SLICE social advertisements are engaging because they are testimonial-based and driven by social connections. Since, in one embodiment, the social advertisements are full-page and created by someone followed by the viewer, these social advertisements are highly effective advertisements and can additionally be precisely targeted by demographics, geography, context, behavior and social relationships.

Importantly, although various embodiments of a social advertising platform are discussed as if the service were implemented at a centralized web location, it is contemplated that such a platform may be centralized or distributed.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

While for sake of illustration embodiments of the present invention are described from the perspective of an end user, which is typically a consumer of online content, the methods and systems of the present invention are equally applicable to users that are producers of online content.

### TERMINOLOGY

Brief definitions of terms used throughout this application are given below.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The terms “follower,” “friend,” “fan” and “subscriber” are used interchangeably and generally refer to a recipient or viewer of information shared by a sharer. An example of a follower includes, but is not limited to, a Twitter subscriber that is registered to receive tweets of another Twitter subscriber or author. Another example includes a Facebook member that shows their support for a group, company, cause, product or the like by registering as a fan.

The phrases “LINKMERCIAL social advertisement,” “SLICE social advertisement” and “social advertisement” generally refer to an advertisement, such as a big banner, bug display add or full-page interstitial ad, that is displayed to a user responsive to selection of a link shared by a sharer and prior to or concurrently with presentation of the shared content. In one embodiment, a social advertisement includes a short (e.g., 5-second, 10-second or 15-second) advertisement in the form of a multimedia or a video clip featuring or otherwise relating to a company, organization, product, service, brand and/or cause. In one embodiment, social advertisements are presented in the form of full-page, interstitial pages that provide viewers with an opportunity to interact with a brand web page hosted by a social advertising platform, the advertiser via their web site, the originating sharer, fans of the originating sharer, other endorsers of the product, service or brand at issue and/or fans of the product, service or brand at issue.

If the specification states a component or feature “may”, “can”, “could”, or “might” be included or have a characteristic, that particular component or feature is not required to be included or have the characteristic.

The term “responsive” includes completely or partially responsive.

The term “sharer” generally refers to a person or entity that shares links to content. Typically, the sharer posts a Uniform Resource Locator (URL) to content he/she would like to share or bring to the attention of others via a social media channel, such as a blog, Facebook, Twitter, email or the like). Sharers are typically individuals having influence within a particular group and may include celebrities, reporters, bloggers, musicians, athletes, sports stars or ordinary individuals. In various embodiments of the present invention, sharers earn revenue for sharing links and/or click-throughs on shared links. For example, sharers may earn a fixed or sliding scale fee (e.g., $0.01) per link created subject to some configured maximum (e.g., 10 per day) and earn a fixed or sliding scale fee (e.g., $10) CPM per link clicked subject to some configured maximum daily earnings cap.

The term “social media” generally refers to media designed to be disseminated through social interaction. Social media may take on may different forms, including, but not limited to Internet forums, weblogs, social blogs, microblogs, wikis, podcasts, wall-postings, email, instant messaging, social networks, social bookmarking and the like.

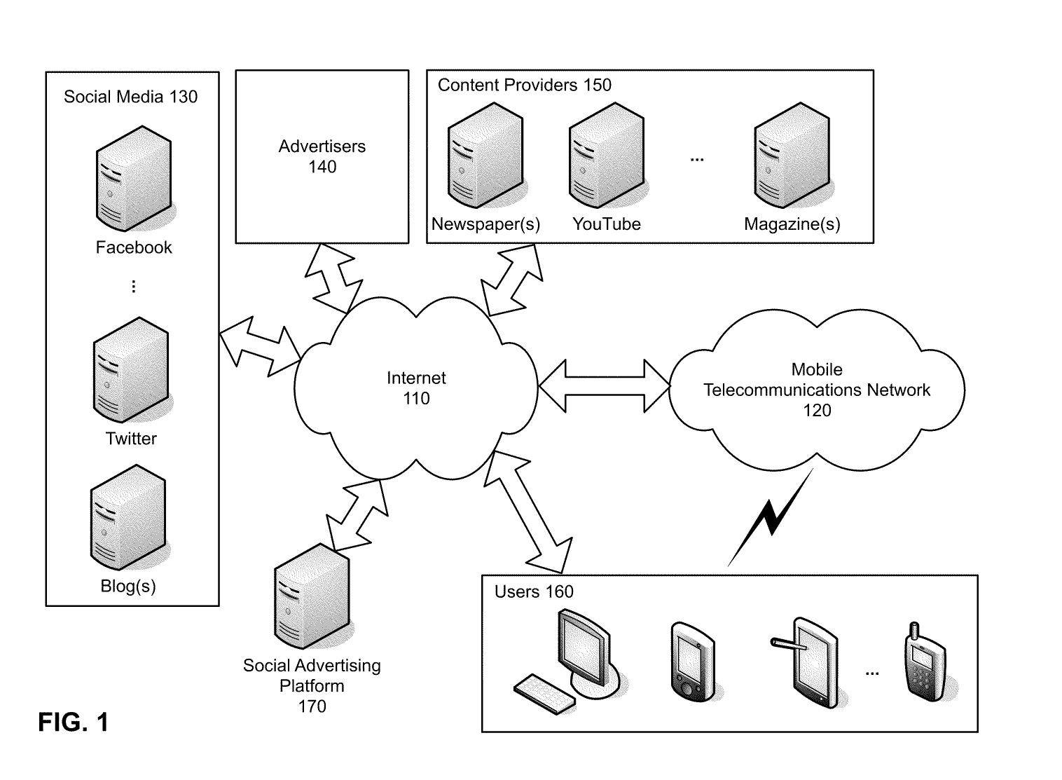

FIG. 1 is a block diagram conceptually illustrating an exemplary network environment in which embodiments of the present invention may be implemented. According to the present example, a public communication network, such as the Internet 110, interconnects social media 130, advertisers 140, content providers 150, a social advertising platform and users 160. Mobile users making use of smart phones (e.g., a BLACKBERRY smartphone device, an IPHONE Internet- and multimedia-enabled smartphone and the like), personal digital assistants and other mobile Internet-enabled devices, such as laptops with wireless cards, may access Internet resources via a mobile telecommunications network 120, which may implement various specifications of the International Telecommunication Union, including, but not limited to 2G, 2.5G, 3G (International Mobile Telecommunications-200 (IMT-2000), GSM EDGE and the like.

Content providers 150 include, but are not limited to, organizations or individuals that create news, information, educational or entertainment content that is accessible via the Internet. Examples of content providers 150 includes magazine-like entities, such as Hot Wired, newspaper websites, such as the New York Times online, portals, blogs, online gaming sites and YouTube.

Advertisers 140 typically include (i) companies desiring to make consumers aware of their products, services, brands and/or the advantages thereof to increase consumption or (ii) organizations (e.g., political parties, interest groups, religious organizations and governmental agencies). Advertisers 140 can also include advertising agencies that create and/or place/distribute advertising on behalf of companies or organizations.

Social media 130 includes companies or services that facilitate the creation and/or delivery of media designed to or having the effect of being disseminated through social interaction. As such, social media 130 includes, but is not limited to existing companies and services, such as Twitter, Facebook, MySpace, LinkedIn and the like, Internet forums, blogs, wikis, podcasts, wall-postings, email, instant messaging and the like, as well as future variations thereof.

According to one embodiment, social advertising platform 170 is a free service that facilitates monetizing content on the web. As described further below, the social advertising platform 170 may compensate sharers/content creators, like bloggers, celebrities, athletes, reporters and musicians for sharing interesting links and/or endorsing their favorite brands.

In the context of various embodiments of the present invention, a sharer (e.g., a content provider or a user) posts, sends, presents or otherwise shares a link to content desired to be shared (e.g., an article in the New York Times online, a You Tube video, a post on a blog, etc.) via social media 130. The link may be shared in the a variety of contexts, including, but not limited to Facebook, Twitter, chat rooms, message boards, web blogs, text messages, Internet Relay Chat (IRC) messages, instant messaging (IM) messages and the like. In the context of Facebook, links to shared content may be conveyed via wall posts, status feeds, news feeds, invitations, notifications, email, private messages or the like. Links to shared content may also be conveyed via email messages originated from a desktop e-mail client, such as Microsoft Outlook, Pegasus Mail, Mozilla's Thunderbird, Apples Inc.'s Mail or the like, free or advertising-supported web-based e-mail services, such as GMAIL, YAHOO! Mail, Hotmail, AOL mail and the like, or a mobile Internet-enabled device.

When fans click-through on the shared links, they may first be presented with or concurrently be presented with advertising content (e.g., a social advertisement containing a 5 to 10-second ad) before they are taken to the targeted content.

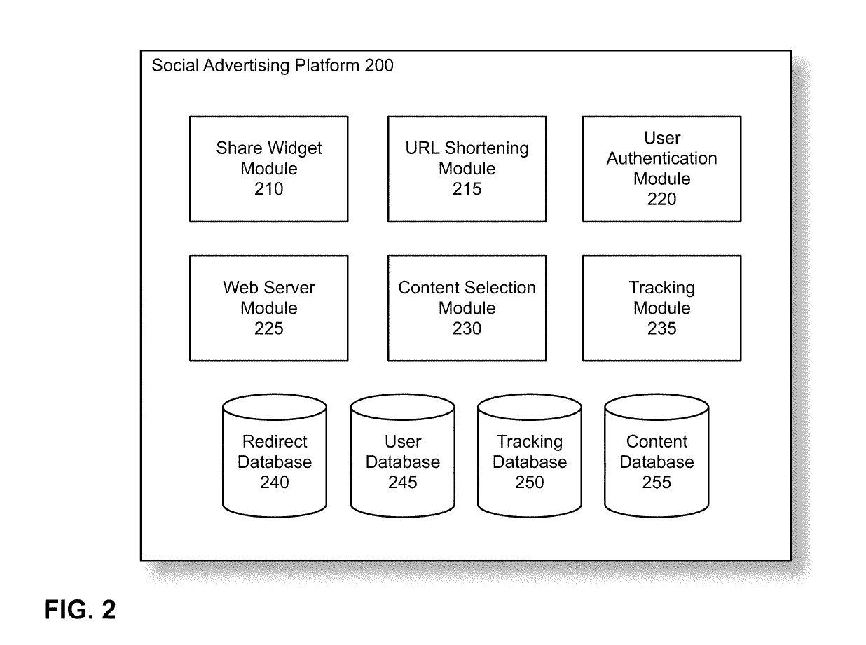

FIG. 2 is a software architecture block diagram conceptually illustrating exemplary functional units of a social advertising platform 200 in accordance with one embodiment of the present invention. According to the current example, the social advertising platform 200 includes a share widget module 210, a URL shortening module 215, a user authentication module 220, a web server module 225, a content selection module 230 and a tracking module 235. The social advertising platform 200 also includes various databases, including a redirect database 240, a user database 245, a tracking database 250 and a content database 255.

The user authentication module 220 creates user accounts and subsequently verifies usernames and passwords for returning registered users (e.g., fans and sharers) of the social advertising platform 200.

The web server module 225 links the social networking website associated with the social advertising platform 200 via the Internet 110 to users 160. The web server module 225 serves web pages, as well as other web-related content, such as Java, Flash, XML and the like. The web server module 225 may include mail server or other messaging functionality for receiving and routing messages between the social advertising platform website and users 160. The messages can be instant messages, queued messages (e.g., email), text and SMS messages or any other suitable messaging technique. According to one embodiment, responsive to receiving requests resulting from click-throughs on shared links, the web server module 225, with assistance from content selection module 230 returns an interstitial advertising web page, such as a social advertisement, in the context of which advertising content may be displayed, and upon completion of the advertising content redirects to the originally targeted (shared) content.

The share widget module 210 is typically invoked by a graphical user interface (GUI) widget or tool displayed by a website (e.g., a social networking website associated with the social advertising platform 200 or the website hosting the content desired to be shared). The share widget module 210 may be invoked while viewing content of interest to be shared by way of a share button as described further below or by way of a share bar associated with the social advertising platform website. In general, the share widget module 210 facilitates the posting/delivery of content via one or more forms of social media by providing an interface to a user's social media accounts and optionally a text entry field for comments relating to the shared content.

The URL shortening module 215 operates in a manner similar to existing URL shorteners, such as bit.ly, tr.im, tinyurl.com, cli.gs, si.ma. budurl.com, is.gd, twurl.nl and others, by taking as an input a URL targeting content of interest and outputting a shortened URL that redirects to the content of interest. However, according to embodiments of the present invention the shared content is displayed only after causing an interstitial ad to be presented to the user triggering the click-through. In one embodiment, the URL shortening module 215 produces a URL that links to an entry in the redirect database 240, which causes a full-page, interstitial ad to be displayed as described further below, prior to transitioning to the linked content.

Depending upon the particular implementation, advertising content may be dynamically or statically associated with the shared content. For example, in one embodiment, advertising content may be dynamically assigned to the interstitial ad by the web server module 225 and the content selection module 230 at the time the shortened URL is selected by a user. Alternatively, the URL shortening module 272 may statically associate advertising content to be included as part of the interstitial ad at the time the shortened URL is generated.

Content selection module 230 selects content from content database 255, which may contain advertising content hosted by the social advertising platform 200. The advertising content may be populated by third party companies, advertisers and/or causes. Alternatively or additionally, the content database 255 may link to external third party content. In one embodiment, the advertising content is tagged to allow selection based on various factors, including, but not limited to product type, product name, service type, service name, brand, company, cause, charity type and/or charity name.

According to one embodiment, the selection of advertising content by the content selection module 230 to be included with or otherwise assigned to an interstitial ad is based on brands, products, services, organizations and/or causes expressly endorsed by the sharer in the context of the social advertising platform 200. As described further below, at the time the sharer identifies him/herself as an endorser of a particular brand, product, service, organization and/or cause, the sharer may also provide a testimonial or user message that will concurrently be displayed with corresponding advertising content. As a result, embodiments of the present invention turn consumers into brand advocates while allowing the consumer some control over advertising content resulting from their shared links. According to one embodiment, only advertising content associated with a brand, product, service, organization and/or cause that has been affirmatively endorsed by a sharer (e.g., by expressly identifying him/herself as an endorser of same by adding the name of the brand, product, service, organization or cause to a list on their profile page, for example, as described further below) can become part of a social advertisement that is displayed before the content shared by the sharer.

Alternatively or additionally, social advertisements may be selected in accordance with a bid for priority mechanism in which advertisers 140 pay to receive preferential treatment for social advertisements or advertising content associated with their companies, brands, products, services and/or causes. In some embodiments, advertisers can pay to redirect the social advertisement to a separate website or they can pay to show extended advertising content. Cost per action of an affiliate advertising model is another possible mechanism that may be used in some embodiments.

The tracking module 235 maintains statistics and information regarding click-throughs and link creation by sharers. In one embodiment, information sufficient to facilitate compensating the sharer is maintained. For example, the tracking module 235 may be informed of links created by a sharer and when shared links are selected/viewed by fans. In alternative embodiments, additional information to facilitate more successful revenue production by sharers or advertisers may be gathered and/or extracted from observations made by the social advertising platform 200. For example, information may be tracked by the social media forms from which click-throughs originate and/or by the social media forms to which shared links are posted. Various other analytics will be apparent to those skilled in the art. For example, in some embodiments, members of the social advertising platform 200 are able to track the number of links they have created, the number of resulting click-throughs and the revenue they have earned through the social advertising platform 200.

Depending upon the particular implementation, these and other modules may be chained together in various configurations. For example, in one embodiment, invocation of the share widget module 210 causes the share widget module 210 to call the URL shortening module 215 with the link to be shared. Alternatively, the sharer may manually cut and past a shortened URL created by the URL shortening module 215 into a text entry field of a share bar for use by the share widget module 210.

The content database 255 may contain video and/or multimedia content provided by advertisers 140 via an advertiser interface module (not shown).

The user database 245 may contain user profile information, information regarding who or what the user is a fan of, the account password, information regarding friends within the peer-to-peer social advertising service and the like. The user database 245 is accessed and modified by the user authentication module 220.

The tracking database 250 may contain information and/or statistics for use in connection with compensating sharers for creating links and click-throughs on created links. The tracking database 250 is accessed and modified by the tracking module 235.

While in the environment of the present example, the various modules have been described as residing within or as part of a single server, in alternative embodiments one or more of these functional units may be implemented across multiple physical and/or logical servers. For example one server may be dedicated to performing web server functionality and another may be dedicated to serving social advertisements.

In various embodiments, the functionality of one or more of the above-referenced functional units/modules may be merged in various combinations. For example, the content selection module 230 and the web server module 225 may be combined. Similarly, the tracking module 235 and/or the share widget module 210 and the URL shortening module 215 may be combined. Moreover, the various functional units/modules can be communicatively coupled using any suitable communication method (e.g., message passing, parameter passing, and/or signals through one or more communication paths, etc.). Additionally, the functional units/modules described herein can be physically connected according to any suitable interconnection architecture (e.g., fully connected, hypercube, etc.).

According to embodiments of the invention, the functional units/modules can be any suitable type of logic (e.g., digital logic, software code and the like) for executing the operations described herein. Any of the functional units/modules used in conjunction with embodiments of the invention can include machine-readable storage media including having tangibly embodied therein instructions for performing operations described herein. Machine-readable storage media include any mechanism that stores information in a form readable by a machine (e.g., a computer). For example, a machine-readable medium includes, but is not limited to, read only memory (ROM), random access memory (RAM), magnetic disk storage media, optical storage media or flash memory devices.

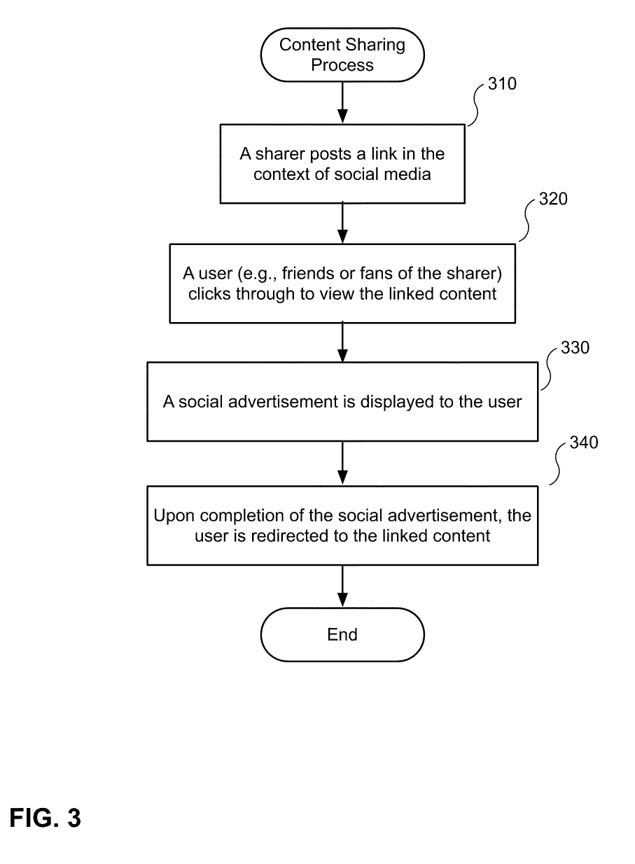

FIG. 3 is a high-level flow diagram illustrating a content sharing process in accordance with an embodiment of the present invention from the sharer/fan perspective. According to the present example, the content sharing process begins at block 310 with a registered user (a sharer) of the social advertising platform 170 posting a link in the context of social media. For example, a sharer may notify fans of content of interest by creating a tweet with an embedded link generated by the social advertising platform 170. As such, the embedded link indirectly points to the targeted content by way of a direct link to advertising content hosted by or retrieved by the social advertising platform 170.

At block 320, another user (e.g., friends or fans of the sharer) clicks-through the shared link to view the shared content.

According to one embodiment, at block 330, rather than immediately being presented with the shared content, a social advertisement is temporarily displayed (e.g., for 5, 10 or 15-seconds) to the user as described further below. Alternatively, the social advertisement may be presented concurrently with the shared content.

At block 340, upon completion of the advertisement content associated with the social advertisement, the user is redirected to the shared content.

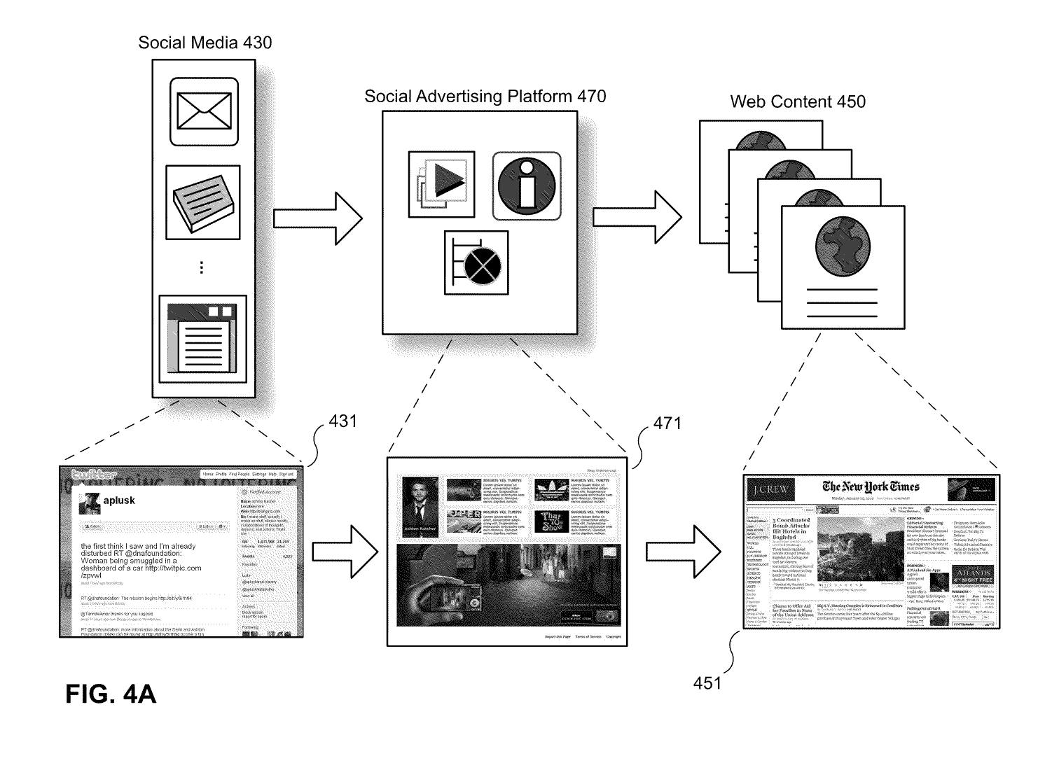

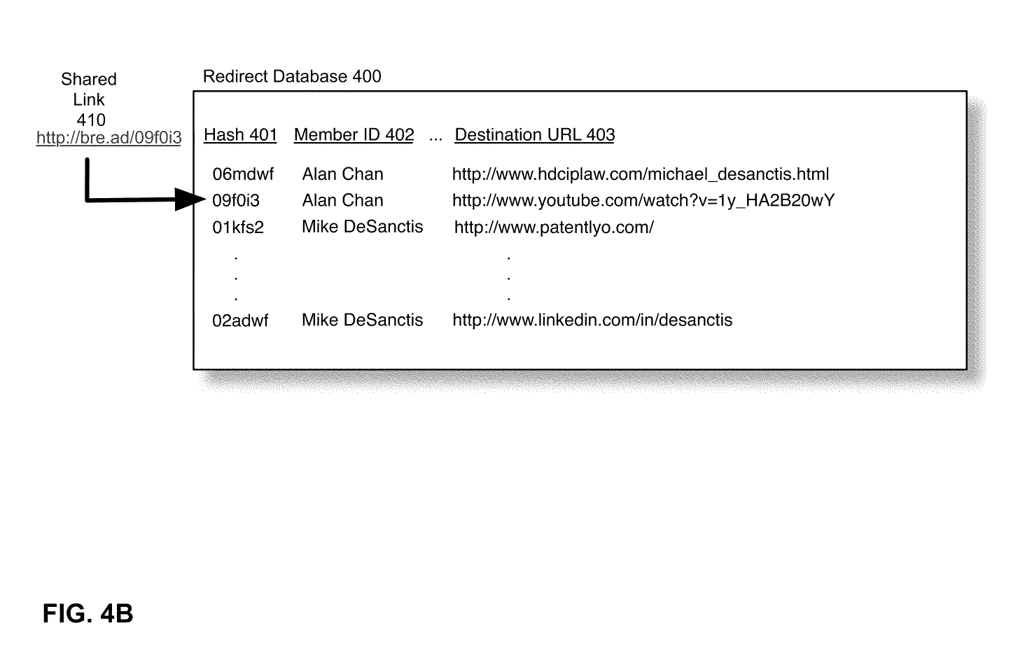

FIG. 4A is a high-level conceptual illustration showing the relationship among websites where shared links might be published, interstitial social advertisement pages and shared content in accordance with an embodiment of the present invention. As indicated earlier, in the context of various embodiments of the present invention, a sharer (e.g., a content provider, company, advertiser or a user) may post a link to content desired to be shared via a form of social media 430 (e.g., Twitter 431). Thereafter, responsive to selection of the shared link, advertising content may be presented in the form of a full-page, interactive, interstitial ad (e.g., a social advertisement 471 as described in more detail below) by a social advertising platform 470. Upon completion of the advertising content, the user is automatically transitioned to the originally targeted web content 450 (e.g., a web page from the New York Times online website).

FIG. 4B conceptually illustrates an example of a redirect database 400 in accordance with an embodiment of the present invention. Redirect database 400 is an example of a database, which might be used in connection with processing click-throughs on shared links generated by the social advertising platform. In the current example, redirect database 400 includes a hash field 401, a member ID field 402 and a destination URL field 403.

According to one embodiment, and as described further below, when a shared link, such as shared link 410, is generated by the social advertising platform to allow a sharer to share content, the social advertising platform forms an association between the shared link 410 and a URL of the content desired to be shared (e.g., destination URL 403). In the present example, the association is in the form of a one-to-one mapping of hash values 401 to destination URLs 403. After a shared link is created by the social advertising platform on behalf of a member, the social advertising platform, among other things, returns the shared link to the member and creates an entry in the redirect database 400 having a hash value, a member ID and a destination URL.

Subsequently, when a shared link, such as shared link 410, is selected, a web server (e.g., web server 225) associated with the social advertising platform uses the hash portion of shared link 410, which in the context of the present example is “09f0i3,” to identify the corresponding member ID 402 of the sharer of shared link 410 and the corresponding destination URL 403. With this information, the social advertising platform may (i) in real-time select advertising content (e.g., based on information associated with the sharer's member profile, such as endorsed/recommended brands, companies, products, services, organizations, causes and/or charities) to be included as part of a social advertisement; and (ii) redirect the requestor to a social advertising page (e.g., an interstitial ad), which temporarily displays the selected advertisement before redirecting the requestor to the destination URL 403 corresponding to the shared link 410.

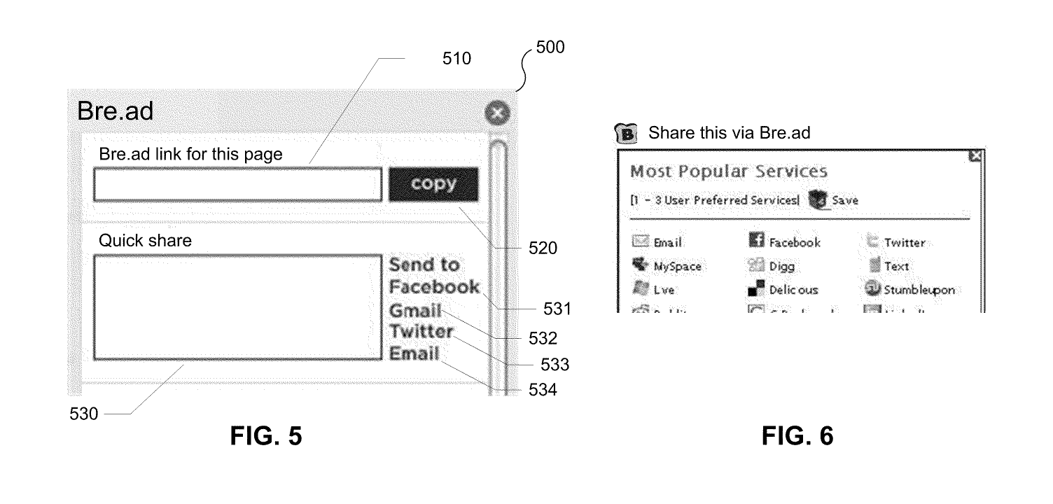

FIG. 5 illustrates an example of a share widget 500 that may be used to generate indirect links to content via a social advertising platform in accordance with an embodiment of the present invention. According to the present example, the shorted (indirect) URL generated by the social advertising platform is presented in text field 510. The sharer can then select the copy button 520 to copy the shortened URL to the clipboard to paste wherever they please. Alternatively, the sharer can type a quick message in the quick share text entry field 530 and select the social media form (e.g., Facebook 531, Gmail 532, Twitter 533 or Email 534) to which they would like to post the message and the social advertising platform interfaces with the selected social media form to effectuate the post.

FIG. 6 illustrates another type of share widget that may be used to generate indirect links to content via a social advertising platform in accordance with an embodiment of the present invention. According to the present example, content providers may facilitate sharing of their content by installing a share widget that enables members of the social advertising network to quickly and easily select a social media form to which he/she would like to post a link to the content at issue.

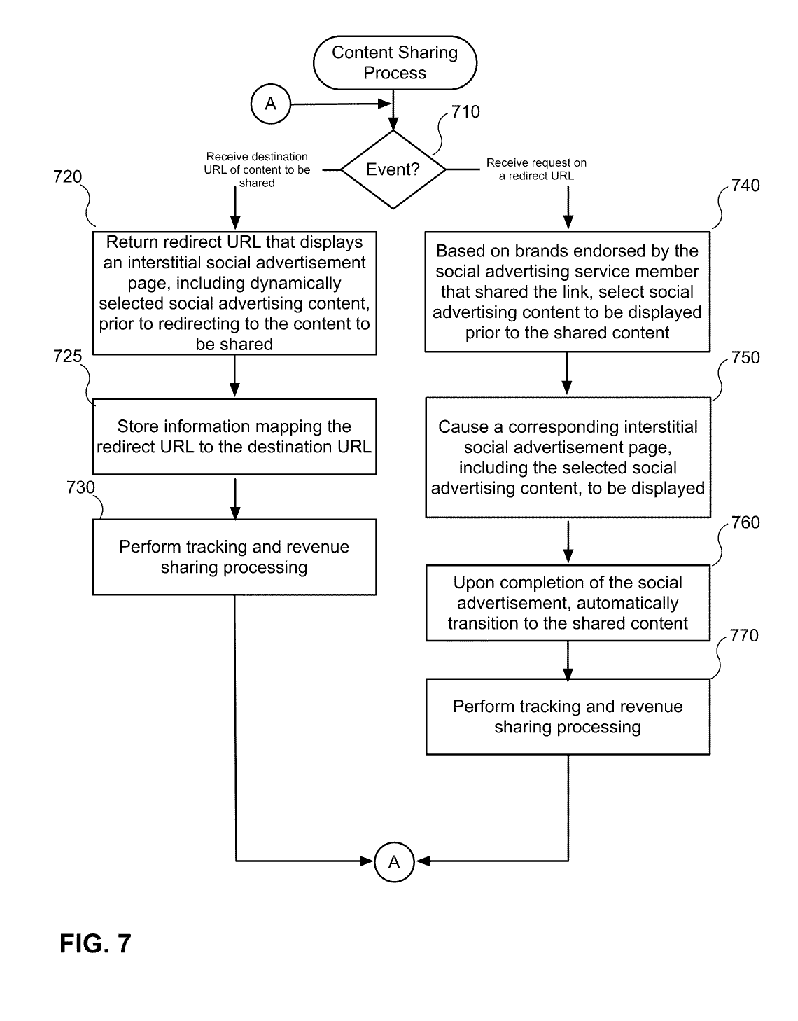

FIG. 7 is a flow diagram illustrating a process of sharing content in accordance with an embodiment of the present invention from the perspective of the social advertising platform. According to the current example, the content sharing process begins at decision block 710 at which an event-processing module of the social advertising platform receives and distinguishes among various user events. If the event represents receipt of a URL associated with content to be shared, then processing continues with block 720; otherwise if the event represents a request on a shortened and/or indirect URL (a redirect URL) previously created by the social advertising platform and shared by a sharer, then processing continues with block 740.

At block 720, a shortened, redirect URL is returned that directly links to static or dynamically generated social advertisement (e.g., an interstitial social advertisement page, including currently or future selected social advertising content) and indirectly links to the content to be shared.

At block 725, information mapping the redirect URL to the destination URL (the URL of the content to be shared) is stored by the social advertising platform. According to one embodiment, at least a hash portion of the redirect URL and the destination URL are stored in a database (e.g., redirect database 240) to facilitate subsequent redirect processing responsive to click-throughs on the redirect URL. As described above, additional information, including, but not limited to information regarding the member of the social advertising platform (e.g., member ID 402) may also be stored to facilitate dynamic selection of advertising content at the time of click-through processing of shared links.

At block 730, desired tracking and revenue sharing processing may be performed. For example, if statistics and/or information are maintained regarding shared link creation, the social media form to which shared links are posted, etc., this information can be logged at this time. Additionally or alternatively, if the sharer is compensated based on shared link creation, information regarding the number of shared links created by the originating sharer of the link at issue can be updated. At this point, the content sharing processing returns to decision block 710 to process the next event.

At block 740, responsive to receiving a request on a redirect URL created by social advertising platform, based on brands, products, services, companies and/or causes recommended or endorsed by the sharer, advertising content is selected to be part of an interstitial social advertisement, which will be displayed prior to the shared content. According to one embodiment, selection of the advertising content to be associated with the shared link is strictly limited to those corresponding with the companies, products, services, brands and/or causes expressly endorsed/recommended by the sharer. In some embodiments, candidate advertising content may first be filtered based on sharer recommendation/endorsement. Then, optionally, additional filtering may be applied to filter out advertising content that would violate content restrictions or parameters imposed by the sharer. For example, embodiments of the present invention may allow a sharer to disallow certain advertising content (e.g., adult content, content involving alcohol, content involving tobacco, etc.) from being associated with their shared content. Final advertising content may be selected from the group of remaining candidate advertising content in accordance with a bid for priority mechanism in which advertisers 140 pay to receive preferential treatment for advertising content associated with their companies, brands, products, services and/or causes. Alternatively, a round-robin selection mechanism may be used to give equal viewing time to each candidate advertising content. In other embodiments, advertising content selection may take into consideration whether, how often and how recently advertising content has been viewed across the user base of the social advertising platform and select advertising content so as to balance one or more of these factors. For example, if all advertising content of the candidate advertising content has been viewed, advertising content that has been least recently viewed, viewed the least number of times, least recently viewed based on the source of the click-through or viewed the least number of times based on the source of the click-through may be given priority.

In alternative embodiments, the advertising content selected to be associated with the social advertisement page may be randomized not based on endorsements made by the sharer, but rather based on endorsements made by other members followed by the sharer or other members followed by the member clicking through on the shared link. In such an embodiment, responsive to receiving a request on a redirect URL created by the social advertising platform, advertising content may be selected to be part of the interstitial social advertisement based on its perceived relevance to the shared content and/or to the requestor. For example, assume there is a first member of the social advertising platform that follows, among others, Lady Gaga, and this first member clicks on a link shared by a second member of the social advertising platform. In one embodiment, in addition to or instead of displaying advertising content based on brands, products, services, companies and/or causes recommended or endorsed by the second member, the first member may be presented with an interstitial social advertisement that includes advertising content selected based upon endorsements of Lady Gaga. In some embodiments, the sharer would first have to opt into such a program and would still share in revenues associated with his/her link production and/or link click-throughs.

At block 750, the social advertising platform causes the corresponding interstitial social advertisement page, including the previously dynamically selected advertising content, to be displayed. In alternative embodiments, the advertising content selection and static assignment may be performed at the time of redirect URL generation; however, real-time, dynamic selection of advertising content at the time of redirect URL processing has the benefit of selecting advertising content from a more up-to-date list of recommended/endorsed companies, brands, products, services and/or causes of the originating sharer, for example. In one embodiment, the social advertisement page is caused to be displayed by performing a redirection (e.g., an HTML redirect, a JavaScript redirect or a 301 redirect) to the social advertisement page as dynamically modified to include, for example, the selected advertising content, information regarding the sharer and a testimonial or comment regarding the endorsed company, brand, product, service and/or cause.

In some embodiments, a cookie or other mechanism may be used to limit the number of times a particular user is presented with a social advertisement. For example, in one embodiment, a time and date stamped cookie is downloaded to the user's computer each time they view a social advertisement. Based on the cookie or absence of the cookie, the social advertising platform may only display subsequent social advertisements to the user if it has been greater than a predetermined or configurable amount of time (e.g., 5, 10 or 15 minutes).

At block 760, after the advertising content associated with the social advertisement completes, the shared content is displayed. According to one embodiment, the shared content is displayed by performing yet another redirection (e.g., an HTML redirect, a JavaScript redirect or a 301 redirect) to the shared content (e.g., the destination URL 403 corresponding to the shared link 410).

At block 770, desired post-redirect tracking and revenue sharing processing may be performed. For example, if statistics and/or information are maintained regarding click-throughs, the social media form from which the click-through originated, etc., such information can be logged at this time. Additionally or alternatively, if the sharer is compensated based on click-throughs, information regarding the number of click-throughs for the originating sharer of the link at issue can be updated. At this point, the content sharing processing returns to decision block 710 to process the next event.

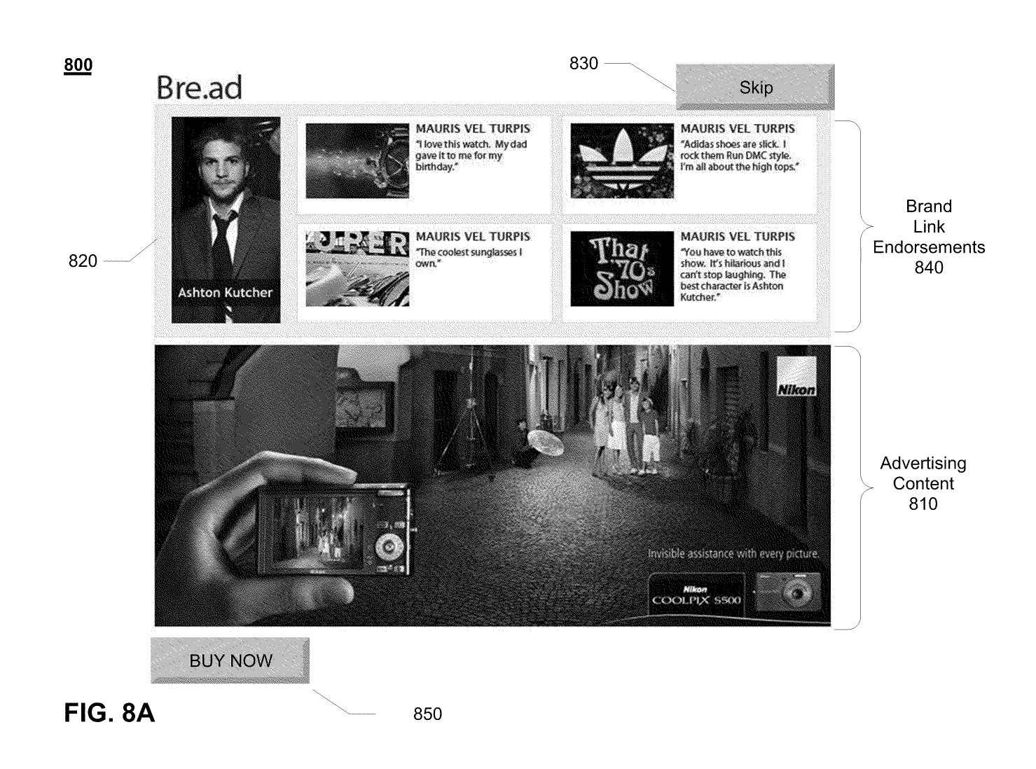

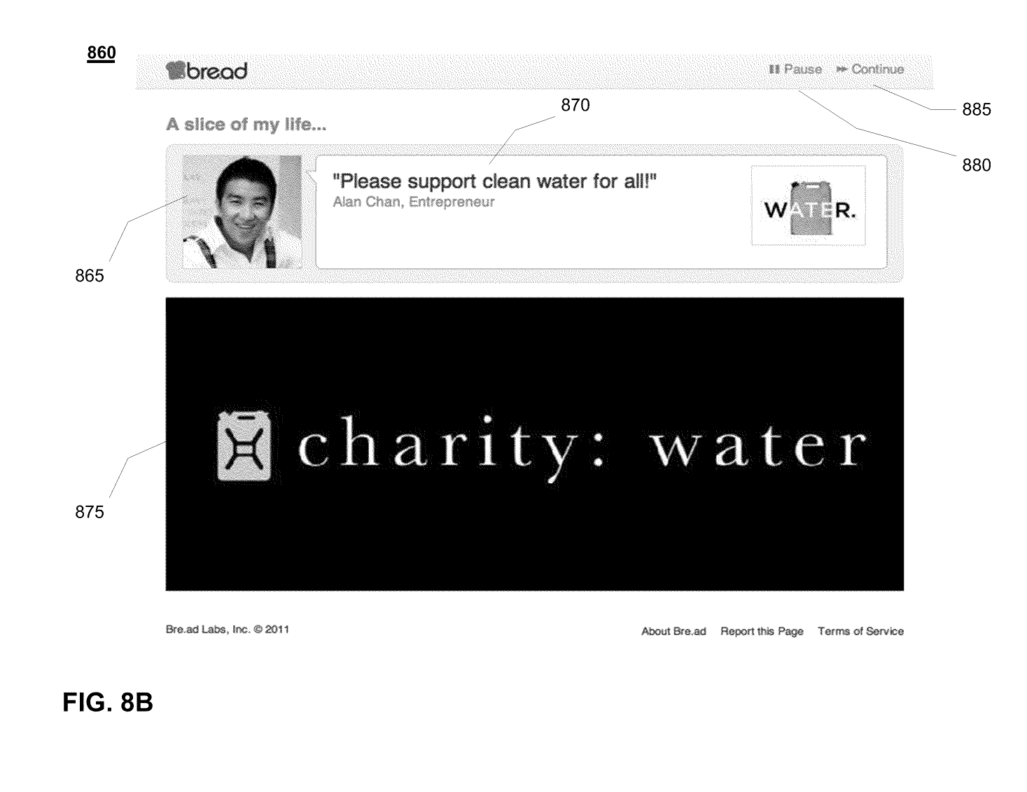

FIG. 8A is an example of an interstitial social advertisement page 800 in accordance with an embodiment of the present invention. According to the present example, the interstitial social advertisement page 800 is full-page and interactive and includes a link to the originating sharer's member page 820, brand link endorsements 840, advertising content 810, a skip button 830 and a buy now button 850.

According to one embodiment, the social advertisement page 800 is displayed responsive to a user selecting a shared link and before redirecting to the shared content. In one embodiment, the advertising content 810 is a short (e.g., 5, 10 or 15-second video advertisement), a big banner or a big display ad. The user can skip the social advertisement by selecting the skip button 830.

During the timed presentation of the advertising content 810, the user may also interact with the social advertisement page 800. For example, the user may purchase the product or service that is the subject of the advertising content 810 by selecting the buy now button 850. The user may also select link 820 to be taken to the originating sharer's member page on the social networking website associated with the social advertising platform. Finally, the user may select one of the brand link endorsements 840 to be taken to either a hosted brand page on the social networking website associated with the social advertising platform or to the advertiser's website.

In alternative embodiments, the social advertisement page 800 may be smaller and displayed concurrently with the shared content. In some embodiments, the user may additionally be provided with the ability to pause, rewind and/or forward the advertising content 810.

FIG. 8B is another example of an interstitial social advertisement page 860 in accordance with an embodiment of the present invention. According to the present example, the interstitial social advertisement page 860 is full-page and interactive and includes a link to the originating sharer's member page 865, a comment by the originating sharer 870 (e.g., a testimonial regarding the endorsed company, product, service, organization or cause), hyperlink advertising content 875, a pause button 880 and a continue button 885.

According to one embodiment, the social advertisement page 860 is displayed responsive to a user selecting a shared link and before redirecting to the shared content. In one embodiment, the advertising content 875 is a short (e.g., 5, 10 or 15-second) pictorial, multimedia or video advertisement, a big banner or a big display ad. The user can pause the social advertisement by selecting the pause button 880 and continue to the shared content by selecting the continue button 885.

Depending upon the implementation, during the timed presentation of the advertising content 875, the user may also interact with the social advertisement page 860. For example, by making a selection within the advertising content 875, the user may be taken to a hosted page on the social advertising platform having additional information, material and/or links relating to the subject matter at issue in the advertising content 875 or the user may be taken to an official website associated with the advertising content 875 (e.g., a company, advertiser or cause website). The user may also select link 865 to be taken to the originating sharer's member page on the social networking website associated with the social advertising platform.

As indicated above, in alternative embodiments, the social advertisement page 850 may be smaller and displayed concurrently with the shared content. In some embodiments, the user may additionally be provided with the ability to comment on the advertising content 875 and/or save a link to the advertising content 875 for later review.

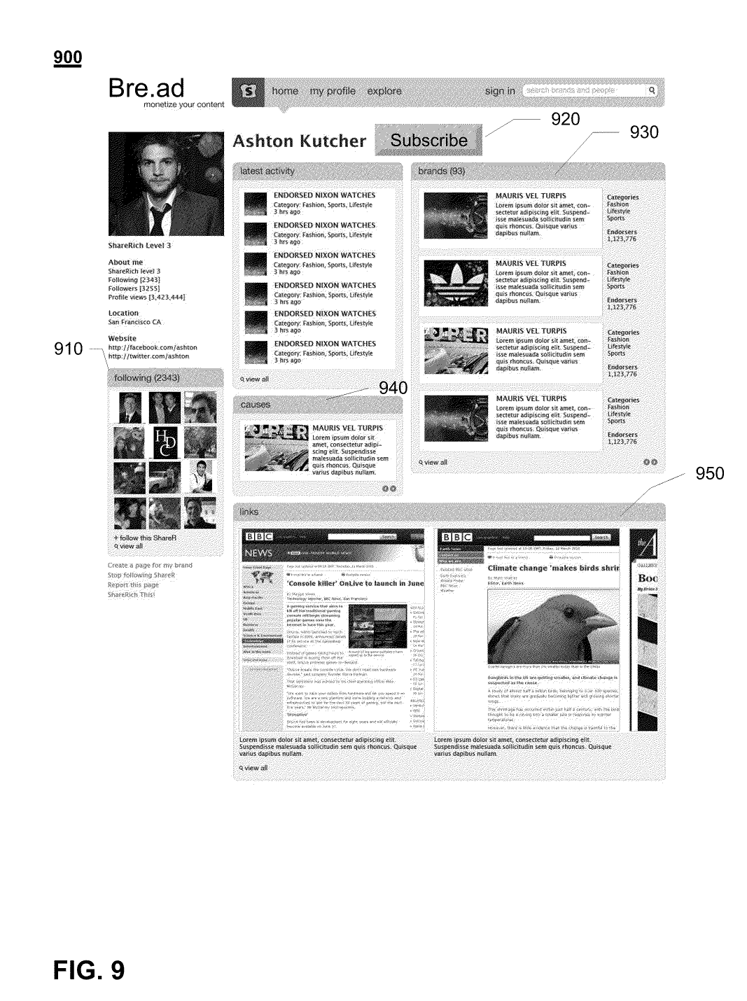

FIG. 9 is an example of a member page 900 within the social advertising platform in accordance with an embodiment of the present invention. According to the present example, user profile information regarding the member is displayed along with an indication regarding subscribers/followers 910, a subscribe button 920, a list of brands recommended/endorsed by the member 930, a list of causes recommended, endorsed or otherwise supported by the member 940, a list of links 950 and other information. According to one embodiment, the member page 900 acts in a manner similar to a Facebook member page. For example, selection of the subscribe button 920 operates to add the subscribing member to the list of followers/subscribers 910 and may enable the subscriber to receive updates in the form of wall posts, status feeds, news feeds, invitations, notifications and the like based on the sharer's activities as appropriate.

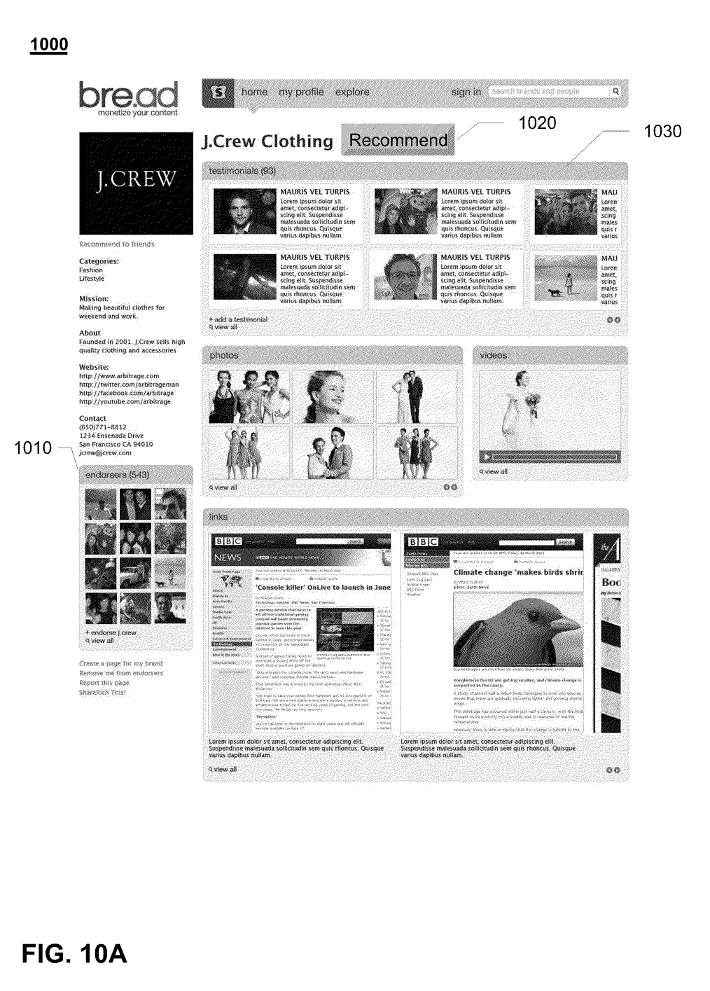

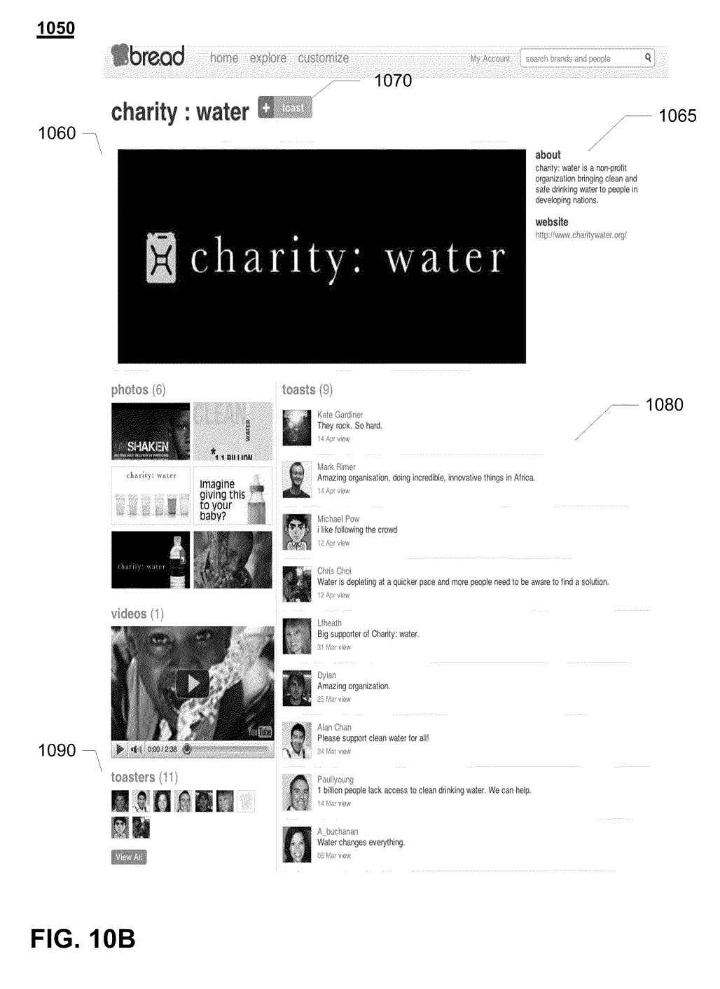

FIG. 10A is an example of a brand page 1000 that may be hosted by the social advertising platform in accordance with an embodiment of the present invention. According to the present example, brand profile information regarding the brand is displayed along with an indication regarding recommenders/endorsers 1010, a recommend button 1020, a list of members that have provided testimonials regarding the brand 1030, and other information and links. According to one embodiment, the brand page 1000 acts in a manner similar to a Facebook fan page. For example, selection of the recommend button 1020 operates to add the recommender to the list of recommenders/endorsers 1010 and provides the recommender with an opportunity to provide a brief textual testimonial.

FIG. 10B is an example of a cause page 1050 that may be hosted by the social advertising platform in accordance with an embodiment of the present invention. According to the present example, cause profile information 1065 is displayed along with an indication regarding recommenders/endorsers, a recommend (“toast”) button 1070, a list of members (“toasters” according to the present example) that have provided testimonials regarding the cause 1090, and other information and links. According to one embodiment, the cause page 1050 acts in a manner similar to a Facebook fan page. For example, selection of the toast button 1070 operates to add the recommender to the list of toasters 1090 and provides the recommender with an opportunity to provide a brief textual testimonial 1080. Additionally, in this example, when a member becomes a supporter (“toaster”) of the cause, banner ad 1060 as well as the member's testimonial will periodically be used as part of a social advertisement (such as that depicted in FIG. 8B, for example) displayed to those clicking through to see shared content by the member. In this manner, the social advertising platform supports user-generated advertising content and allows members to market and otherwise advocate brands, companies, organizations, charities, causes, products and/or services they support.

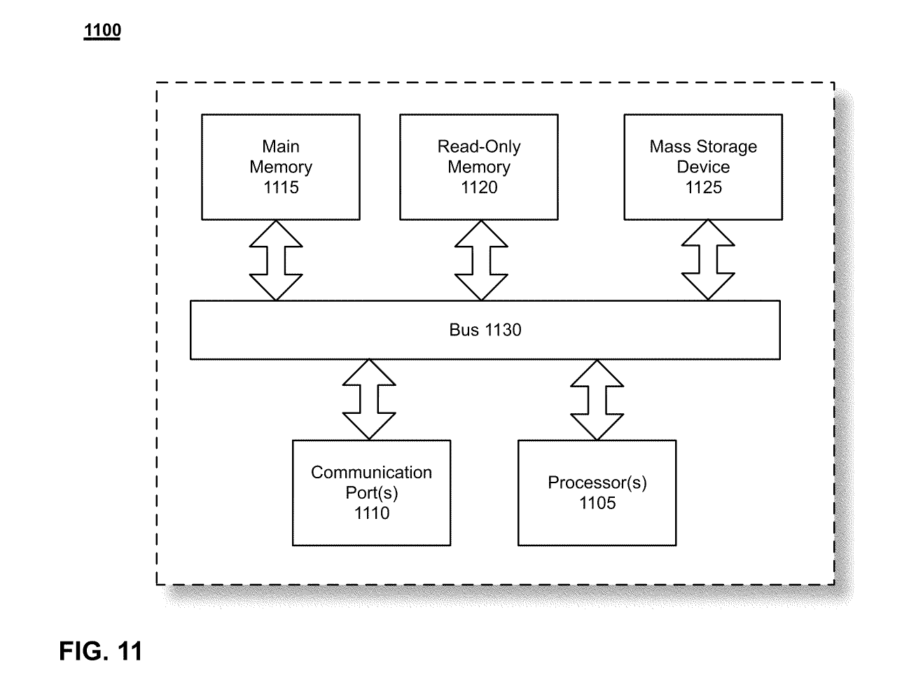

FIG. 11 is an example of a computer system with which embodiments of the present invention may be utilized. Embodiments of the present invention include various steps, which will be described in more detail below. A variety of these steps may be performed by hardware components or may be tangibly embodied on a computer-readable medium in the form of machine-executable instructions, which may be used to cause a general-purpose or special-purpose processor programmed with instructions to perform these steps. Alternatively, the steps may be performed by a combination of hardware, software, and/or firmware. As such, FIG. 11 is an example of a computer system 1100, such as a client (e.g., a workstation, personal computer, laptop, mobile device or the like) or server, upon which or with which embodiments of the present invention may be employed.

According to the present example, the computer system includes a bus 1130, one or more processors 1105, one or more communication ports 1110, a main memory 1115, a removable storage media 1140, a read only memory 1120 and a mass storage 1125.

Processor(s) 1105 can be any future or existing processor, including, but not limited to, an Intel® Itanium® or Itanium 2 processor(s), or AMD®, Opteron® or Athlon MP® processor(s), or Motorola® lines of processors. Communication port(s) 1110 can be any of an RS-232 port for use with a modem based dialup connection, a 10/100 Ethernet port, a Gigabit port using copper or fiber or other existing or future ports. Communication port(s) 1110 may be chosen depending on a network, such a Local Area Network (LAN), Wide Area Network (WAN), or any network to which the computer system 1100 connects.

Main memory 1115 can be Random Access Memory (RAM), or any other dynamic storage device(s) commonly known in the art. Read only memory 1120 can be any static storage device(s) such as Programmable Read Only Memory (PROM) chips for storing static information such as start-up or BIOS instructions for processor 1105.

Mass storage 1125 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 1130 communicatively couples processor(s) 1105 with the other memory, storage and communication blocks. Bus 1130 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 1105 to system memory.

Optionally, operator and administrative interfaces, such as a display, keyboard, and a cursor control device, may also be coupled to bus 1130 to support direct operator interaction with computer system 1100. Other operator and administrative interfaces can be provided through network connections connected through communication ports 1110.

Removable storage media 1140 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

Components described above are meant only to exemplify various possibilities. In no way should the aforementioned exemplary computer system limit the scope of the invention.

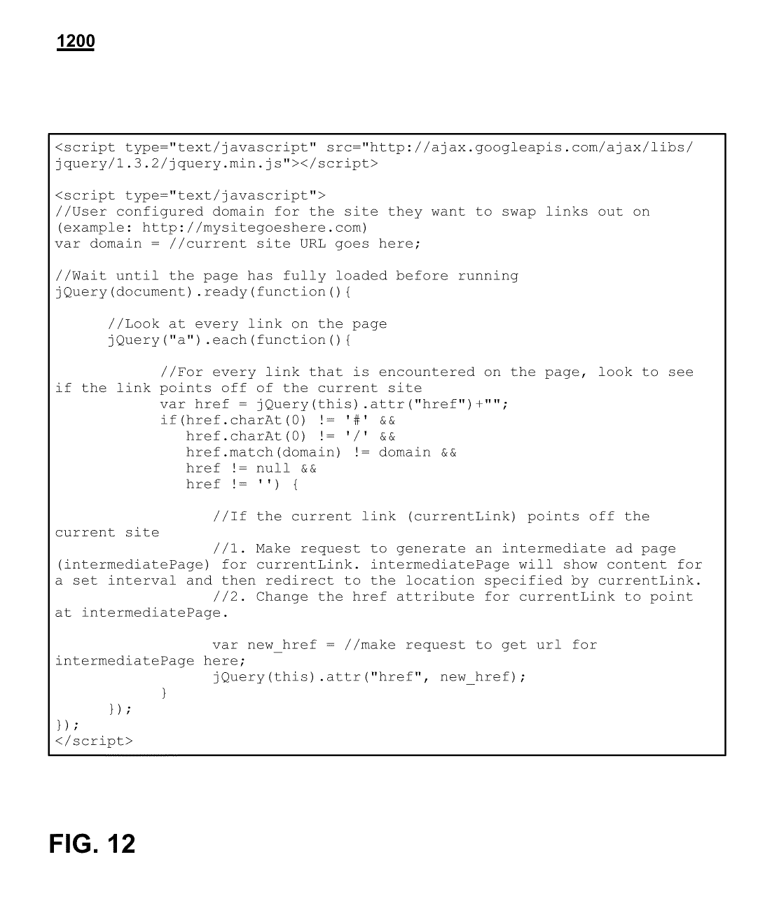

FIG. 12 is an example of a link conversion script 1200 in accordance with an embodiment of the present invention. According to the present example, the link conversion script 1200 is installed in the header or footer of a website of a content provider. The script 1200 does the following: (i) finds any HTML links on the site that point off of the site (i.e., direct to another domain) and (ii) change the HTLM link so that it points at another page. In one embodiment, the new outbound HTML links generated to replace the existing outbound HTML links first display an intermediate ad page, e.g., interstitial social advertisement page 800 or 860, before automatically redirecting the user to the page that was originally linked to from the existing outbound HTML link.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A computer-implemented method comprising:
maintaining, by one or more routines running on one or more computer systems of a peer-to-peer social advertising service, profile information for each member of a plurality of members of the peer-to-peer social advertising service, the profile information including a list of brands, products, services, companies, organizations, charities or causes recommended or endorsed by the member;
generating a shared link corresponding to a destination link through which a member of the plurality of members can share content associated with the destination link with third parties via social media;
responsive to receiving a click-through event for the shared link from a requestor, redirecting the requestor, by a web server running on the one or more computer systems, to a social advertisement containing advertising content selected based upon the list of brands, products, services, companies, organizations, charities or causes recommended or endorsed by the member; and
after a temporary display of the advertising content is completed, redirecting the requestor, by the web server, to the destination link.

2. The method of claim 1, wherein said generating a shared link comprises generating a shortened Universal Resource Locator (URL) corresponding to a URL of the destination link.

3. The method of claim 1, further comprising causing the advertising content to be temporarily displayed to the requestor by performing a 301 redirect to a URL associated with the social advertisement.

4. The method of claim 3, wherein the social advertisement further includes a testimonial or comment by the member regarding a brand, product, service, company or cause associated with the selected advertising content.

5. The method of claim 1, wherein the selected advertising content comprises flash or video content.

6. The method of claim 1, further comprising responsive to receiving the click-through event for the shared link, dynamically selecting the advertising content by identifying a candidate set of advertising content by filtering available advertising content based on the list of brands, products, services, companies, organizations, charities or causes recommended or endorsed by the member.

7. The method of claim 6, further comprising selecting advertising content from among the candidate set based on a round-robin selection algorithm.

8. The method of claim 6, further comprising selecting advertising content from among the candidate set based on a bid for priority algorithm.

9. The method of claim 6, further comprising selecting advertising content from among the candidate set that has been least recently viewed.

10. The method of claim 6, further comprising selecting advertising content from among the candidate set that has been viewed a least number of times.

11. A non-transitory program storage device, readable by one or more processors of one or more computer systems of a peer-to-peer social advertising service, tangibly embodying a program of instructions executable by the one or more processors to perform method steps for displaying a social advertisement, said method steps comprising:
maintaining profile information for each member of a plurality of members of the peer-to-peer social advertising service, the profile information including a list of brands, products, services, companies, organizations, charities or causes recommended or endorsed by the member;
generating a shared link corresponding to a destination link through which a member of the plurality of members can share content associated with the destination link with third parties via social media;
responsive to receiving a click-through event for the shared link from a requestor, redirecting the requestor to a social advertisement containing advertising content selected based upon the list of brands, products, services, companies, organizations, charities or causes recommended or endorsed by the member; and
after a temporary display of the advertising content is completed, redirecting the requestor to the destination link.

12. The program storage device of claim 11, wherein said generating a shared link comprises generating a shortened Universal Resource Locator (URL) corresponding to a URL of the destination link.

13. The program storage device of claim 11, wherein the method further comprises causing the advertising content to be temporarily displayed to the requestor by performing a 301 redirect to a URL associated with the social advertisement.

14. The program storage device of claim 13, wherein the social advertisement further includes a testimonial or comment by the member regarding a brand, product, service, company or cause associated with the selected advertising content.

15. The program storage device of claim 11, wherein the selected advertising content comprises flash or video content.

16. The program storage device of claim 11, wherein the method further comprises responsive to receiving the click-through event for the shared link, dynamically selecting the advertising content by identifying a candidate set of advertising content by filtering available advertising content based on the list of brands, products, services, companies, organizations, charities or causes recommended or endorsed by the member.

17. The program storage device of claim 16, wherein the method further comprises selecting advertising content from among the candidate set based on a round-robin selection algorithm.

18. The program storage device of claim 16, wherein the method further comprises selecting advertising content from among the candidate set based on a bid for priority algorithm.

19. The program storage device of claim 16, wherein the method further comprises selecting advertising content from among the candidate set that has been least recently viewed.

20. The program storage device of claim 16, wherein the method further comprises selecting advertising content from among the candidate set that has been viewed a least number of times.
